(19) United States
(12) Patent Application Publication
(10) Pub. No.: US 2002/0074941 A1
(43) Pub. Date: Jun. 20, 2002

(54) PLASMA DISPLAY PANEL THAT IS OPERABLE TO SUPPRESS THE REFLECTION OF EXTRANEOUS LIGHT, THEREBY IMPROVING THE DISPLAY CONTRAST

(76) Inventor: SHINYA FUJIWARA, KYOTO (JP)

Correspondence Address: WENDEROTH LIND & PONACK, 2033 K STREET,N.W. SUITE 800, WASHINGTON, DC, 20006

(21) Appl. No.: 09/274,339

(22) Filed: Mar. 23, 1999

(30) Foreign Application Priority Data
Mar. 24, 1998 (JP) 10-075250

(51) Int. Cl. H01J 17/49

(52) U.S. Cl. 313/584

(57) ABSTRACT

A plasma display device with improved display contrast and panel performance is provided. A front substrate 7 is constituted from a transparent first insulating substrate 1, and a plurality of stripe-shaped first electrodes 4 including at least one discharge electrode and extending parallel to each other. A rear substrate 13 is constituted from a second insulating substrate 8, a plurality of second electrodes 9 extending parallel to each other, and a plurality of ribs 11 forming a plurality of discharge spaces 10 therebetween. The discharge electrode includes transparent electrode 2a, a black-colored first conductive layer 2c, and a second conductive layer 2d. The second conductive layer 2d has a lower resisitivity than the first conductive layer 2c and is made with widths smaller than those of the first conductive layer 2c and extends to the edge of the first insulating substrate 1.

### BACKGROUND OF THE INVENTION

1. Field of the Invention

The present invention relates to a plasma display panel used for displaying images of television, computer and other apparatuses.

2. Description of Related Art

An example of a plasma display panel of the prior art will be described below with reference to FIG. 7 which is a partially cutaway perspective view of an AC type plasma display panel.

The plasma display panel has such a configuration that a front substrate including a transparent first insulating substrate 51, a plurality of pairs of stripe-shaped scanning electrode 52 and sustaining electrode 53, a dielectric layer 54, and a protection layer 55 formed in this order, and a rear substrate including a second insulating substrate 56, a plurality of stripe-shaped data electrodes 57 extending perpendicular to the scanning electrode 52 and the sustaining electrode 53, and stripe-shaped ribs 59 formed on the second insulating substrate 56 forming a plurality of discharge spaces therebetween, the front and rear substrate are formed one upon another. The scanning electrode 52 and the sustaining electrode 53 include stripe-shaped transparent electrode 52a, 53a that are electrically conductive, and conductive layer 52b, 53b, respectively. The conductive layer formed on the transparent electrode is in the shape of stripe having smaller width than the transparent electrode, and contains silver. Metals such as copper and chromium can be employed instead of silver in the conductive layer, as is disclosed in U.S. Pat. No. 3,943,007.

The discharge space 58 is filled with a discharge gas including at least one kind of rare gas chosen from helium, neon, argon, krypton and xenon. When the panel is used for color display, a phosphor 60 (only a part of which is shown) is formed to extend over the data electrodes 57 to the side face of the ribs 59.

Now the operation of the AC type plasma display panel of the prior art will be described below.

In a sustaining period of a drive operation, a pulse voltage is applied alternately between the scanning electrode 52 and the sustaining electrode 53 so that sustaining discharge is generated in the discharge space 58 by an electric field generated between the surface of the protection layer 55 on the dielectric layer 54 over the scanning electrode 52 and the surface of the protection layer 55 on the dielectric layer 54 over the sustaining electrode 53, thereby to produce an image with visible light generated by the sustaining discharge. To provide color display, the phosphor 60 is excited by ultraviolet rays emitted by the sustaining discharge and an image is produced by using visible light emitted by the phosphor 60.

On the other hand, in an addressing period of a drive operation, a pulse voltage is applied between the data electrodes 57 and the scanning electrode 52 or the sustaining electrode 53 in order to generate an addressing discharge.

In any case, the panel is configured to allow the image to be viewed from the front substrate side of the panel.

A method for forming the scanning electrode 52, the sustaining electrode 53, the dielectric layer 54 and the protection layer 55 on the first insulating substrate 51 will be described below taking reference to FIG. 8 which shows a cross sectional view along a projected line in FIG. 7.

In FIG. 8, stripe-shaped transparent electrodes 52a, 53a made of an electrically conductive material such as tin oxide (SnO) or indium tin oxide (ITO) are formed on the transparent first insulating substrate 1 which, with silver paste printed thereon, is dried and fired thereby to make stripe-shaped conductive layers 52b, 53b including silver. Entire surface of this substrate is coated with glass paste which is dried and fired thereby to make the vitrified dielectric layer 54, which is further covered by the protection layer 55 formed by vapor deposition of manganese oxide (go).

However, the conductive layers 52b, 53b of this panel have high reflectivity of the surface because the conductive layers 52b, 53b contain silver which is added to improve conductivity. Consequently, extraneous light is reflected on the surface of the conductive layers 52b, 53b as indicated by a solid line in FIG. 8, resulting in a problem of significantly low contrast of the display.

### SUMMARY OF THE INVENTION

To solve the problems described above, the present invention provides a plasma display panel including front and rear substrate formed one upon another; the front substrate including a transparent first insulating substrate, a plurality of stripe-shaped first electrodes extending parallel to each other, and each electrode including at least one stripe-shaped discharge electrode; the discharge electrode including a transparent electrode, a black-colored first conductive layer and a second conductive layer formed in this order, the second conductive layer having a lower resisitivity than the first conductive layer; the rear substrate including a second insulating substrate, a plurality of second electrodes formed on the second insulating substrate so as to extend parallel to each other, and a plurality of ribs formed on the second insulating substrate so as to separate neighboring second electrodes, forming a plurality of discharge spaces therebetween; and the plurality of first electrodes extending generally perpendicular to the plurality of second electrodes.

This configuration makes it possible to suppress the reflection of extraneous light because the black-colored first conductive layer is formed on the transparent first insulating substrate, thereby improving the display contrast and the panel characteristics. Deterioration in the conductivity due to the black color of the first conductive layer can be compensated for by the second conductive layer which has a low resistivity.

The first conductive layer is made of a material selected from ruthenium oxide and a compound oxide of ruthenium.

With this configuration, a black conductive film which does not reflect light can be formed and, even when float glass of lower production cost is used for the transparent first insulating substrate, there occurs no yellowish discoloration due to reaction of light transmitted through the transparent electrode and the float glass, thus enabling almost complete blackening.

The second conductive layer contains silver.

This makes it possible to form a conductive film of lower resistivity which, when a voltage is applied, causes lower voltage drop and lower time constant.

The second conductive layer has a width not greater than that of the first conductive layer.

This eliminates the possibility of the second conductive layer to lie beyond the edge of the first conductive layer even when the first conductive layer and the second conductive layer are misaligned when forming. Consequently, reflection of light by the second conductive layer can be completely eliminated even when misalignment occurs.

The second conductive layer extends to a terminal portion of the first insulating substrate to be connected with an external electrode.

Thus because only an effective display area can be blackened and the bonding strength with the float glass which makes the transparent first insulating substrate can be increased, connection with external circuits can be made more stable and reliable.

Also the second conductive layer includes a plurality of layers.

This configuration makes it possible to form a conductive film of lower resistivity, and form a film which shuts off the transfer of silver below the conductive layer that contains silver.

### BRIEF DESCRIPTION OF THE DRAWINGS

The above and other objects and features of the present invention will become more apparent from the following description of preferred embodiments thereof with reference to the accompanying drawings, throughout which like parts are designated by like reference numerals.

FIG. 1 is a partially cutaway perspective view of the AC type plasma display panel according to the first embodiment of the present invention;

FIG. 2 is top view of the front substrate of FIG. 1 at an edge thereof,

FIG. 3 is a cross sectional view of an edge of the front substrate taken along a projected line of FIG. 2;

FIG. 4 is a cross sectional view taken along the projected line of FIG. 1;

FIG. 5 is a cross sectional view for explaining the relationship between misalignment of the second conductive layer and extraneous light;

FIG. 6 is a partially cutaway perspective view of the DC type plasma display panel according to the second embodiment of the present invention;

FIG. 7 is a partially cutaway perspective view of the AC type plasma display panel of the prior art; and

FIG. 8 is a cross sectional view taken along the projected line of FIG. 7.

### DESCRIPTION OF THE PREFERRED EMBODIMENTS

This application is based on application No. 10-075250 filed Mar. 24, 1988 in Japan, the content of which is incorporated hereinto by reference.

### Embodiment 1

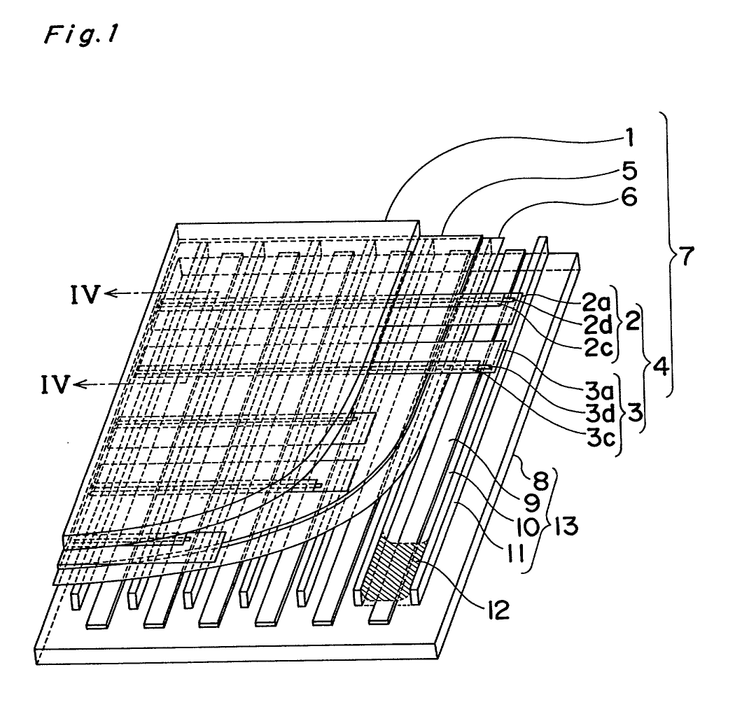

FIG. 1 is a partially cutaway perspective view of an AC type plasma display panel according to the first embodiment of the present invention.

The plasma display panel has such a configuration that a front substrate 7 and rear substrates 13, formed one upon another; the front substrate 7 including a transparent first insulating substrate 1, a plurality of stripe-shaped first electrodes 4 extending parallel to each other, a dielectric layer 5, and a protection layer 6 formed in this order; the rear substrate 13 including a second insulating substrate 8, a plurality of second electrodes 9 (called as data electrodes in this embodiment) formed on the second insulating substrate 8 so as to extend parallel to each other, and a plurality of ribs 11 formed on the second insulating substrate 8 so as to separate neighboring second electrodes 9, forming a plurality of discharge spaces 10 therebetween; and the plurality of first electrodes 4 extending generally perpendicular to the plurality of second electrodes 9. The first electrode includes two discharge electrodes, which are a scanning electrode 2 and a sustaining electrode 3. The scanning electrode 2 and the sustaining electrode 3 include stripe-shaped transparent electrodes 2a, 3a, stripe-shaped black-colored first conductive layers 2c, 3c having width smaller than those of the transparent electrode, and second conductive layers 2d, 3d formed in this order, respectively, the second conductive layer have lower resistivity than the first conductive layer.

The second conductive layers 2d, 3d are formed with widths smaller than those of the first conductive layers 2c, 3c, and extend to the edge of the transparent first insulating substrate 1.

The black-colored first conductive layers 2c, 3c are formed from ruthenium oxide or a compound oxide of ruthenium, while the second conductive layers 2d, 3d are formed from conductive film containing silver.

The discharge space 10 is filled with a discharge gas including at least one kind of rare gas chosen from helium, neon, argon, krypton and xenon.

When the panel is used for color display, a phosphor 12 (only a part of which is shown) is formed to extend over the data electrodes 9 to the side face of the ribs 11.

Now the operation of the AC type plasma display panel will be described below.

In a sustaining period of a drive operation, pulse voltage is applied alternately between the scanning electrode 2 and the sustaining electrode 3 so that sustaining discharge is generated in the discharge space 10 by an electric field generated between the surface of the protection layer 6 on the dielectric layer 5 over the scanning electrode 2 and the surface of the protection layer 6 on the dielectric layer 5 over the sustaining electrode 3, thereby to produce an image with visible light generated by the sustaining discharge. To provide color display, the phosphor 12 is excited by ultraviolet rays emitted by the sustaining discharge and an image is produced by using visible light emitted by the phosphor 12.

In any case, the panel is configured to allow the image to be viewed from the front substrate side of the panel.

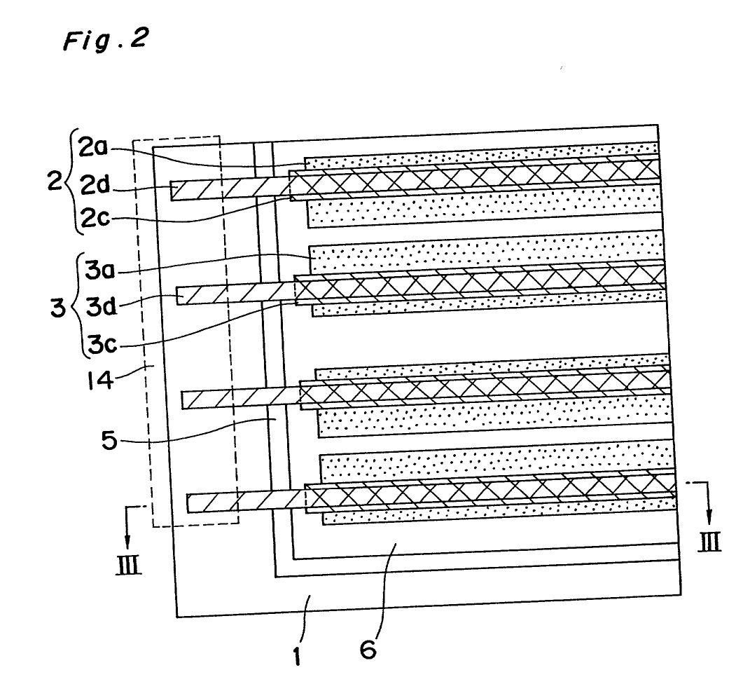

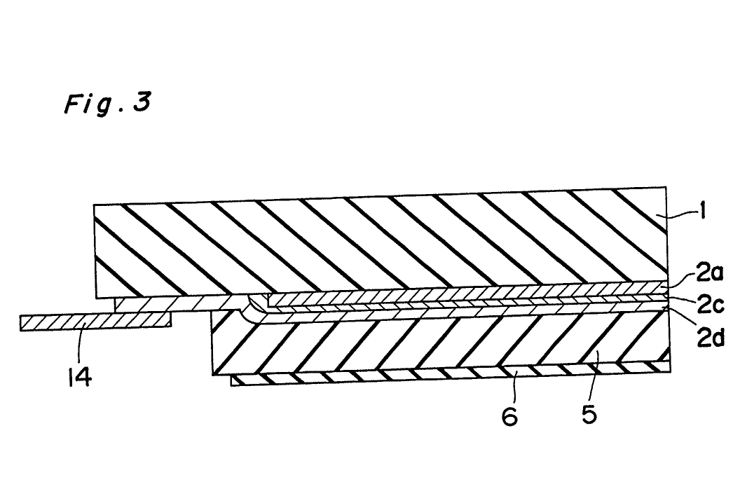

A method for forming the scanning electrode 2, the sustaining electrode 3, the dielectric layer 5 and the protection layer 6 on the first insulating substrate 1 will be described below talking reference to FIG. 2 which is a top view of an edge of the front substrate of FIG. 1 and FIG. 3 which shows a cross sectional view taken along the projected line in FIG. 2.

First, the stripe-shaped transparent electrodes 2a, 3a made of SnO₂ or ITO are formed on the transparent first insulating substrate 1 which, with the black-colored first conductive layers 2c, 3c made of ruthenium oxide or a compound oxide of ruthenium in stripes of smaller width than those of the transparent electrodes 2a, 3a printed thereon, is dried and fired. At this time, edges of the transparent electrodes 2a, 3a and the edges of the black-colored first conductive layer 2c, 3c are formed not to reach the edge of the first insulating substrate 1.

The black-colored first conductive layer may be made of a material other than ruthenium oxide or a compound oxide of ruthenium, for example a mixture of an inorganic pigment such as iron, nickel, cobalt which have been commonly used for blackening and silver is capable of blackening the conductive layer. However, the glass used for the transparent first insulating substrate 1 is usually made in a production process referred to as a floating process which causes tin atoms to be diffused into the glass. When the glass with silver placed thereon is fired at a high temperature, for example 550° C., silver is diffused to the surface of the glass and reacts to the tin atoms thereby causing yellowish discoloration in the glass surface near the silver.

While the AC type plasma display panel has the transparent electrode disposed between the glass and the black first conductive layer, silver atoms in the first conductive layer penetrate the transparent electrode and reach the glass surface thereby reacting to the tin atoms.

Although degree of blackening can be increased by increasing the proportion of the inorganic pigment to silver, this decreases the conductivity. Thus a certain level of silver content is required to make the layer conductive, and therefore it is difficult to completely blacken the layer by mixing the inorganic pigment.

Although a black material having an inorganic pigment is capable of substantially complete blackening when the glass surface is polished or protected by a tin free glass material or the like, but this increases the labor requirement and hence the production cost, and is not practically feasible.

Therefore the black-colored first conductive layer is made of ruthenium oxide or a compound oxide of ruthenium which does not cause yellowish discoloration even when diffused into the glass, and is capable of almost complete blackening even when float glass which can be produced at a lower cost is used.

Then the stripe-shaped second conductive layers 2d, 3d having width smaller than that of the black-colored first conductive layers 2c, 3c are printed on the first conductive layers, and are fired after drying. Silver content of the second conductive layers 2d, 3d is made 95% or higher to have a low resistivity so that voltage drop does not occur when pulse voltage is applied between the scanning electrode 2 and the sustaining electrode 3.

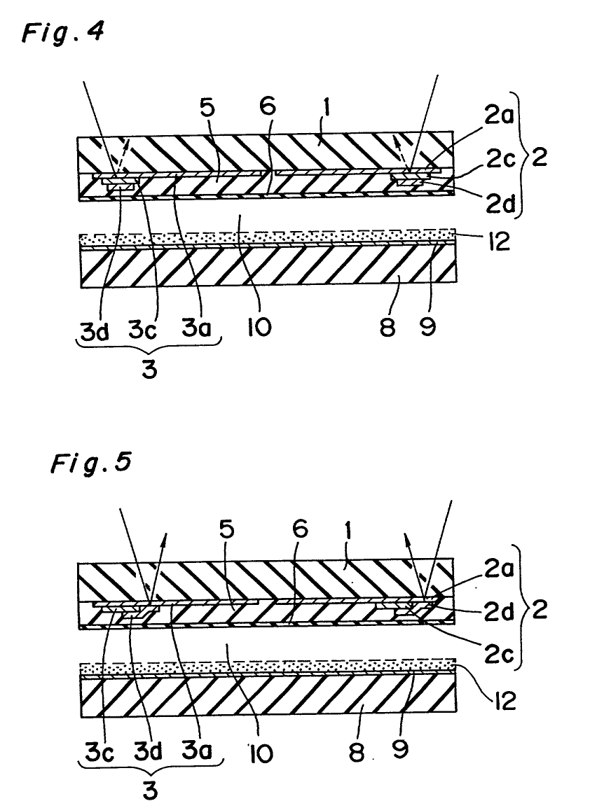

Operation and effect of the present invention will be described below with reference to FIG. 4 which shows a cross sectional view taken along the projected lines of FIG. 1.

By forming the black-colored first conductive layer between the transparent electrodes 2a, 3a and the second conductive layers 2d, 3d which are used to apply the voltage to the scanning electrode 2 and the sustaining electrode 3, extraneous light incident thereon as indicated by the solid line in FIG. 4 is absorbed to leave very weak reflection as indicated by the dashed arrow in the drawing, thus improving the display contrast.

The reason for making the stripe-shaped second conductive layers 2d, 3d with smaller width than those of the black-colored first conductive layers 2c, 3c is as follows. In case the first and second conductive layers are formed with the same width, a misalignment is caused by a problem in the processing accuracy thus causing a strip of the second conductive layer to be formed off an underlying strip of the first conductive layer when forming the second conductive layer on the black-colored first conductive layer as shown in FIG. 5. The misalignment will cause the strip of the second conductive layer which includes silver to be formed on the transparent electrodes 2a, 3a, where it should not be formed, resulting in the portion of the second conductive layer containing silver which lies on the transparent electrode reflecting extraneous light thereby deteriorating the display contrast.

Also because the second conductive layer contains silver as described above, the glass of the first insulating substrate 1 is discolored to become yellowish in the misplaced portion of the second conductive layer. This makes a region of the transparent electrode near the misplaced portion of the second conductive layer clouded thus causing poor contrast.

Processing accuracy is difficult to improve for a large screen such as 42-inch display.

By making the stripe-shaped second conductive layers 2d, 3d with smaller width than those of the black-colored first conductive layers 2c, 3c so that misalignment due to the processing accuracy has no significant effect, the problem described above can be solved thus resulting in a stable process where improvement of display contrast by blackening is not compromised and improved production yield.

In such a case as a photoresist pattern is formed after forming a film for the first conductive layer and a film for the second conductive layer, and then the first conductive layer and the second conductive layer are formed by etching, there is no possibility of misalignment between the first conductive layer and the second conductive layer, and therefore the first conductive layer and the second conductive layer may be made with the same width.

Edges of the stripe-shaped second conductive layers 2d, 3d are formed to extend to the edge of the first insulating substrate 1 for the connection to external circuits as shown in FIG. 2 and FIG. 3. While the black-colored first conductive layers 2c, 3c can be extended to the edge of the first insulating substrate 1, the first conductive layers are not extended to the edge of the first insulating substrate 1 because ruthenium oxide or a compound oxide of ruthenium that makes the first conductive layer has lower bonding strength with the glass that makes the first insulating substrate 1 than that of the second conductive layers 2d, 3d made of a mixture of silver and frit glass.

The portion covered by the dielectric layer 4 is not subject to extraneous mechanical force when incorporated in a panel as shown in FIG. 3 and therefore does not require much bonding strength with the glass that makes the first insulating substrate 1. However, edges of the glass, where a flexible printed circuit board (FPC) 14 is connected by thermocompression bonding of solder or anisotropic conductive film (ACF) for the connection with the external circuits, are required to have higher bonding strength. Usually thermocompression bonding operation causes thermal shock of a duration from 2 to 5 seconds at 200° C. to 250° C. and the external circuit also applies pulse voltage after bonding, and therefore high reliability is required.

The material made by mixing silver and frit glass can have high bonding strength when the mixing proportions are adjusted properly. By extending only the stripe-shaped second conductive layers 2d, 3d made of such a material to the edge of the glass, stable connection with the external circuit can be made with high reliability without compromising the effect of blackening of the effective display area.

### Embodiment 2

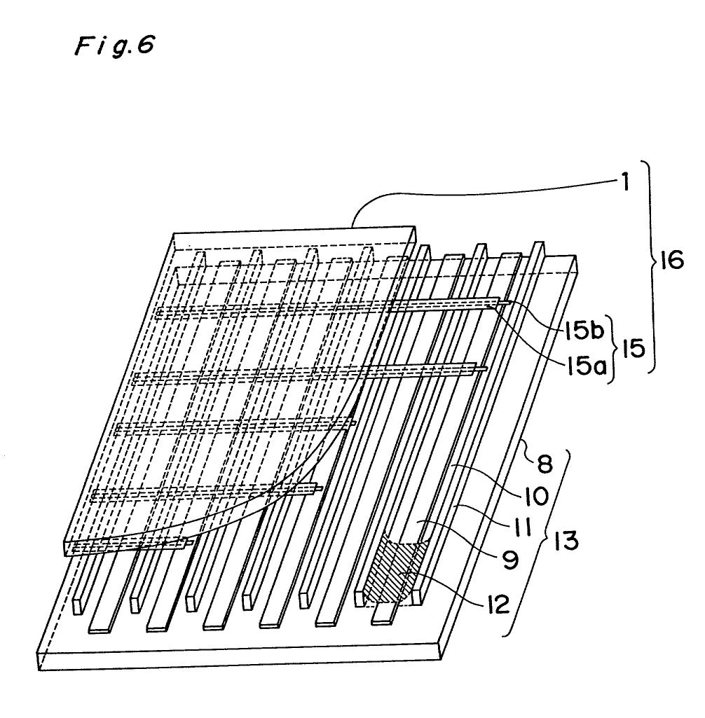

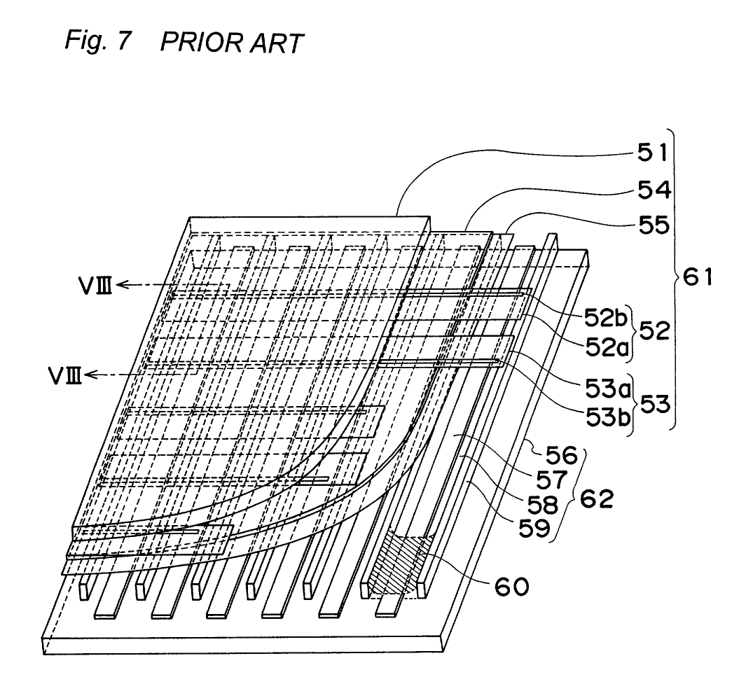

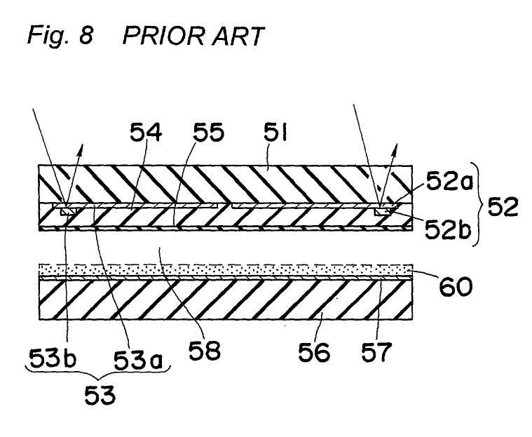

FIG. 6 is a partially cutaway perspective view of a DC type plasma display panel according to the second embodiment of the present invention.

The plasma display panel has such a configuration as a front substrate 16, including a first insulating substrate 1, and a plurality of first electrodes 15 disposed in parallel to each other as cathodes, and a rear substrate 13, including a plurality of stripe-shaped second electrodes 9 as anodes extending generally perpendicular to the plurality of first electrodes 15, and the stripe-shaped ribs 11 formed between the second electrodes 9 in parallel to each other forming the discharge space 10, are formed one upon another. The first electrode 15 includes a discharge electrode constituted from a stripe-shaped black-colored first conductive layer 15a and a second conductive layer 15b that is formed on the former and have lower resistivity than the former.

The second conductive layer 15b is made with width smaller than those of the first conductive layer 15a, and extends to the edge of the transparent first insulating substrate 1.

The black-colored first conductive layer 15a is formed from ruthenium oxide or a compound oxide of ruthenium, while the second conductive layer 15b is formed from a conductive film including silver.

The discharge space 10 is filled with a discharge gas including at least one kind of rare gas chosen from helium, neon, argon, krypton and xenon.

When the panel is used for color display, a phosphor 12 (only a part of which is shown) is formed to extend over the second electrode 9 to the side face of the ribs 11.

Now the operation of the DC type plasma display panel will be described below.

In a sustaining period of a drive operation, a pulse voltage is applied between the first electrode 15 which serves as the cathode and the second electrode 9 as the anode so that sustaining discharge is generated in the discharge space 10 thereby to produce an image with visible light generated by the sustaining discharge. To provide color display, the phosphor 12 is excited by ultraviolet rays emitted by the sustaining discharge and an image is produced by using visible light emitted by the phosphor 12.

In either case, the panel is configured to allow the displayed image to be viewed from the front substrate side of the panel.

Also in the case of the DC type plasma display panel, the discharge electrode includes the black-colored first conductive layer 15a and the second conductive layer 15b; the second conductive layer 15b formed on the first conductive layer 15a with a width smaller than that of the first conductive layer has a lower resistivity than the first conductive layer, and extends to the edge of the first insulating substrate. Therefore the operation and effect of this embodiment are the same as those of the first embodiment, and description thereof will be omitted.

Although the second conductive layer of the first and second embodiments includes a single conductive layer which contains silver, the second conductive layer may also includes a plurality of layers. When the second conductive layer includes a plurality of layers, a low-resistance film may be provided to improve the conductivity. Further, a film which shuts off transfer of silver may be formed between the second conductive layer that contains silver and the first conductive layer, thereby preventing the glass substrate from clouding.

The plasma display panel according to the present invention, having the black-colored first conductive layer formed between the transparent insulating substrate and the second conductive layer formed thereon for applying voltage, is capable of reducing the reflection of extraneous light, improve the display contrast and improve the panel characteristics.

What is claimed is:

1. A plasma display panel comprising:
front and rear substrates formed one upon another;
said front substrate comprising a transparent first insulating substrate, and a plurality of stripe-shaped first electrodes extending parallel to each other, and each comprising at least one stripe-shaped discharge electrode;
said at least one stripe-shaped discharge electrode comprising a transparent electrode, a black-colored first conductive layer and a second conductive layer formed in this order, said second conductive layer having a lower resisitivity than the first conductive layer;
said rear substrate comprising a second insulating substrate, a plurality of second electrodes formed on said second insulating substrate so as to extend parallel to each other, and a plurality of ribs formed on said second insulating substrate so as to separate neighboring second electrodes, forming a plurality of discharge spaces therebetween; and
said plurality of first electrodes extending generally perpendicular to said plurality of second electrodes.

2. The plasma display panel according to claim 1, wherein the first conductive layers are made of a material selected from ruthenium oxide and a compound oxide of ruthenium.

3. The plasma display panel according to claim 1, wherein the second conductive layer contains silver.

4. The plasma display panel according to claim 1, wherein the second conductive layer has a width not greater than that of the first conductive layer.

5. The plasma display panel according to claim 1, wherein the second conductive layer extends to a terminal portion of the first insulating substrate, the second conductive layer adapted to be connected with an external electrode.

6. The plasma display panel according to claim 1, wherein the second conductive layer comprises a plurality of layers.
